(19) United States
(12) Patent Application Publication
(10) Pub. No.: US 2022/0319209 A1
(43) Pub. Date: Oct. 6, 2022

(54) METHOD AND APPARATUS FOR LABELING HUMAN BODY COMPLETENESS DATA, AND TERMINAL DEVICE

(71) Applicant: Shenzhen Yuntianlifei Technolog Co., Ltd., Shenzhen, Guangdong (CN)

(72) Inventors: Tao WU, Shenzhen, Guangdong (CN); Wenze HU, Shenzhen, Guangdong (CN); Xiaoyu WANG, Shenzhen, Guangdong (CN)

(21) Appl. No.: 17/623,887

(22) PCT Filed: Aug. 14, 2020
(86) PCT No.: PCT/CN2020/109071

§ 371 Date: Dec. 30, 2021

(30) Foreign Application Priority Data
Sep. 29, 2019 (CN) 201910952323.3

(51) Int. Cl. G06V 20/70; G06V 40/10; G06V 10/22; G06T 7/11; G06T 7/70

(52) U.S. Cl. CPC G06V 20/70; G06V 40/103; G06V 10/22; G06T 7/11; G06T 7/70; G06T 2207/20021; G06T 2207/30196; G06V 2201/07

(57) ABSTRACT

A method and an apparatus for labeling human body completeness data, and a terminal device, are provided. The method includes: obtaining an image to be labeled (201); performing human body detection on the image to obtain a first human body frame (202); performing human body key point detection on the image, and determining human body part information according to the human body key points that have been detected (203); performing human body area detection on the image to obtain human body visible region labeling information (204); determining the human body part information associated with the first human body frame, and determining the human body visible region labeling information associated with the first human body frame, to complete the labeling of human body completeness data of the first human body frame (205). The described method can reduce a lot of manpower and material resources, shorten the time for labeling human completeness data, and are benefit rapid iteration of products.

### 1. TECHNICAL FIELD

The present disclosure generally relates to the field of data processing, and especially relates to a method and an apparatus for labeling human body completeness data, and a terminal device.

### 2. DESCRIPTION OF RELATED ART

In the field of intelligent security, pedestrian re-recognition and pedestrian attribute recognition have important significance. However, in practical applications, it is difficult for a camera to capture a fully satisfactory image. Truncation and occlusion of human bodies can be occurred in the image captured by the camera, so that identification difficulty for the human body identification algorithm is increased.

Therefore, how to accurately evaluate human body completeness in an image has become very important for human recognition. In the related art, the human body completeness in the image is evaluated by a human trained body completeness estimation model, however, which requires to manually label a lot of data, so that it results in a high cost, a low efficiency and error-prone, and against rapid iteration of products.

### SUMMARY

The technical problems to be solved: in view of the shortcomings of the related art, the present disclosure relates to a method and an apparatus for labeling human body completeness data, and a terminal device, which can solve problems in the related art that a lot of manpower and material resources are consumed, a long time to label human completeness data is occurred, errors are prone to be occurred, and are against rapid iteration of products by manually labeling the human completeness data.

In a first aspect, a method for labeling human body completeness data according to an embodiment of the present disclosure includes:

obtaining an image to be labeled;

performing human body detection on the image to be labeled, to obtain a first human body frame;

detecting human body key points of the image to be labeled, and determining human body part information according to the human body key points that have been detected;

detecting a human body region of the image to be labeled, to obtain human body visible region labeling information; and

determining human body part information associated with the first human body frame, and determining the human body visible region labeling information associated with the first human body frame, to finish labeling the human body completeness data of the first human body frame.

In a second aspect, an apparatus for labeling human body completeness data according to an embodiment of the present disclosure includes:

an image obtaining module configured to obtain an image to be labeled;

a frame detection module configured to perform human body detection on the image to be labeled, to obtain a first human body frame;

a position detection module configured to detect human body key points of the image to be labeled, and determine human body part information according to the human body key points that have been detected;

a visible region module configured to detect a human body region of the image to be labeled, to obtain human body visible region labeling information; and

an information association module configured to determine human body part information associated with the first human body frame, and determine the human body visible region labeling information associated with the first human body frame, to finish labeling the human body completeness data of the first human body frame.

In a third aspect, a terminal device according to an embodiment of the present disclosure includes, a memory, a processor and computer programs stored in the memory and performed by the processor to implement steps of the above method.

In a fourth aspect, a computer readable storage medium according to an embodiment of the present disclosure is configured to store computer programs performed by a processor to implement steps of the above method.

In a fifth aspect, a computer program product according to an embodiment of the present disclosure is configured to be performed by a terminal device to implement steps of the above method.

Comparing with the related art, the present disclosure provides the advantages as below:

In the method for labeling human body completeness data of the present disclosure, the first human body frame of the image to be labeled is detected, the human body key points of the image to be labeled are detected, the human body part information is determined according to the human body key points, and the human body visible region labeling information of the image to be labeled is detected. And then, the human body part information and the human body visible region labeling information are associated with the corresponding first human body frame, to automatically finish labeling the human body completeness data of the first human body frame, rather than requiring manual participation, thereby manpower and material resources are reduced, a labeling speed is improved, rapid iteration of products is facilitated. Therefore, the present disclosure can solve problems in the related art that a lot of manpower and material resources are consumed, a long time to label human completeness data is occurred, errors are prone to be occurred, and are against rapid iteration of products by manually labeling the human completeness data.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic diagram of a human body image in accordance with an embodiment of the present disclosure.

FIG. 2 is a flowchart of a method for labeling human body completeness data in accordance with an embodiment of the present disclosure.

FIG. 3 is a schematic view of human body part dividing lines in accordance with an embodiment of the present disclosure.

FIG. 4 is a block diagram of an apparatus for labeling human body completeness data in accordance with an embodiment of the present disclosure.

FIG. 5 is a block diagram of a terminal device in accordance with an embodiment of the present disclosure.

### DETAILED DESCRIPTION

In the following description, specific details such as structures of a specific system, a technology, etc. are provided for illustrating rather than qualification purposes for thoroughly understanding of embodiments of the present disclosure. However, one of ordinary skill in the art should be aware that the present disclosure can be realized in other embodiments without these specific details. In other cases, detailed descriptions of well-known systems, devices, circuits, and methods are omitted so that the description of the present disclosure can't be precluded by unnecessary details.

In order to illustrate the technical solution of the present disclosure, specific embodiments are described in detail below.

It can be understood that, when used in the specification and the attached claims, the term “include” is indicated that features, wholes, steps, operations, elements and/or components described exist, without excluding to exist or add one or more other features, wholes, steps, operations, elements, components and/or collections thereof.

It can be also understood that the terms used herein are intended only to describe specific embodiments rather than being intended to limit the present disclosure. As described in the specification and the attached claims, the singular terms “one”, “a” and “the” are intended to include the plural, unless the context clearly indicates otherwise.

It should also be further understood that the term “and/or” described in the specification and the attached claims is indicated that any combination and all possible combinations of one or more of the items is listed in relation to each other, and include the combinations thereof.

As described in the specification and the attached claims, the term “if” can be interpreted in context as “when . . . ” or “once” or “responding to determine” or “responding to detect”. Similarly, the phrases “if determining” or “if detecting [described conditions or events]” can be interpreted depending on contexts to mean “once determining” or “in response to determine” or “once detecting [described conditions or events]” or “in response to detect [described conditions or events]”.

In addition, in the description of the present disclosure, terms “first”, “second”, and “third”, etc., are used only to distinguish the description rather than indicating or implicating a relative importance between elements thereof.

With the development of intelligent security, pedestrian re-recognition and pedestrian attribute recognition are more and more important. When the pedestrian re-recognition and the pedestrian attribute recognition are carried out, the higher the human body completeness in the image is, the better a recognition effect is.

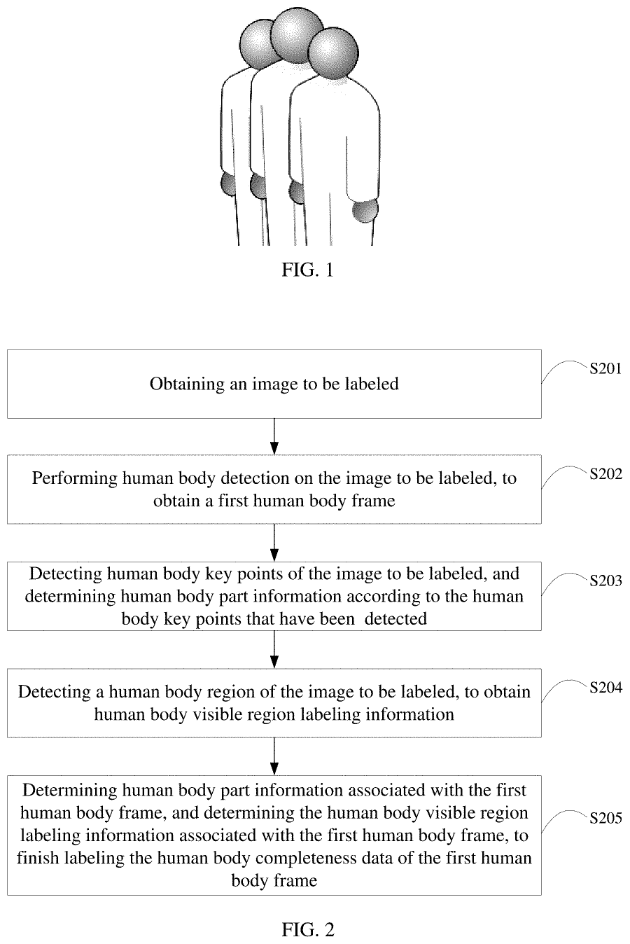

However, in practical application scenarios, human body images captured by the camera are often not perfect. Referring to FIG. 1, in an image captured by the camera, a plurality of people can occlude to each other, even the human body can be occluded by other objects; furthermore, when pedestrians enter or leave a surveillance area of the camera, the image captured by the camera can also be truncated. Recognition difficulty of a pedestrian re-recognition algorithm and a pedestrian attribute recognition algorithm will be increased, when truncation and occlusion of human bodies are occurred.

Therefore, accurate evaluation of human body completeness in the image has become very important for the human recognition. In order to recognize the human completeness in the image, it is necessary to construct and train the human body completeness estimation model.

During training the human body completeness estimation model, a large number of supervised labeling data is needed, and the supervised labeling data refers to an image that is labeled with a position of the human body and completeness data of the human body.

At present, the supervised labeling data is mainly obtained by a manual labeling mode. In order to ensure accuracy of the human body completeness estimation model, the large number of supervised labeling data is needed, in this way, a large number of manpower and material resources are consumed by using the manual labeling mode, and a long time is taken for the labeling, so that the rapid iteration of products is not facilitated.

In order to solve the above problems, a method and an apparatus for labeling human body completeness data, and a terminal device according to an embodiment of the present disclosure, are provided, which are described in details below.

### A First Embodiment

Referring to FIG. 2, a method for labeling human body completeness data according to a first embodiment of the present disclosure is described as follows:

step S201, obtaining an image to be labeled;

when it is necessary to label the human completeness data, the image to be labeled is first obtained.

The image to be labeled can be an image in which a human body region is preliminarily screened and determined, and the human body completeness data is labeled through the method of the first embodiment; or, the image to be labeled can also be an original image without being pre-processed, and it is impossible to determine whether a human body region is included therein, the method of the first embodiment is provided to perform the human body recognition and label the human body completeness data.

When labeling the human body completeness data of the image to be labeled, all a position of a target human body, human body part information and human body visible region labeling information need to be determined. Therefore, in the embodiment of the present disclosure, a combination of a plurality of algorithms can be used for labeling the human body completeness data of the image to be labeled.

Step S202, performing human body detection on the image to be labeled, to obtain a first human body frame;

After obtaining the image to be labeled, a target detection algorithm is configured to perform the human body detection on the image to be labeled, to obtain the first human body frame.

The target detection algorithm can predict an occluded part of the human body, that is, the occluded part of the human body can be included in the first human body frame when the human body is occluded.

A type of the target detection algorithm can be selected according to actual requirements. In some possible implementations, a Yolo-v3 algorithm can be selected as the target detection algorithm, and the human body detection is performed on the image to be labeled through the Yolo-v3 algorithm, to obtain the first human body frame.

After the first human body frame is detected by the target detection algorithm, the first human body frame can also be expanded according to a preset expansion rule, to obtain a new first human body frame, and to further improve usage flexibility of the first human body frame, so that both an un-occluded part and the occluded part of the human body can be included in the new first human body frame. For example, after the first human body frame is detected by the target detection algorithm, a position of the first human body frame is labeled as (x, y, w, h), wherein x is an abscissa of a vertex at the top left corner of the first human body frame, y is an ordinate of the vertex at the top left corner of the first human body frame, w is a width of the first human body frame, and h is a height of the first human body frame. It is assumed that the preset expansion rule is: the first human body frame is horizontally expanded by 0.3w pixels respectively towards the left and the right, and then longitudinally expanded upward by 0.05h pixels, finally, longitudinally expanded by 0.2 pixels downward, so that the position of the new first human body frame can be labeled as (x−0.3*w, y−0.05*h, 1.6 w, 1.25*h).

Step S203, detecting human body key points of the image to be labeled, and determining human body part information according to the human body key points that have been detected;

The human body key points of the image to be labeled can be detected through a pose estimation algorithm, when detecting the human body part information. Because the pose estimation algorithm can be configured to only detect the human body key points with the un-occluded part of the human body, the human body part information with the un-occluded part of the human body can be determined according to the human body key points that have been detected. For example, if the head of the human body is occluded, the pose estimation algorithm can't detect key points of the head; otherwise, if the pose estimation algorithm detects the key points of the head, it means that regions around the key points are un-occluded.

A type of the pose estimation algorithm can be selected according to actual requirements. In some possible implementations, an OpenPose algorithm can be selected as the pose estimation algorithm, and the human body key point detection is performed on the image to be labeled through the OpenPose algorithm, and the human body part information is determined according to the human body key points that have been detected.

The Openpose algorithm can detect 17 key points of the human body, which are: a nose (Nose), a right eye (RightEye), a left eye (LeftEye), a right ear (RightEar), a left ear (LeftEar), a right shoulder (RightShoulder), a left shoulder (LeftShoulder), a right bow (RightBow), a left bow (LeftBow), a right wrist (RightWrist), a left wrist (LeftWrist), a right hip (RightHip), a left hip (LeftHip), a right knee (RightKnee), a left knee (LeftKnee), a right ankle (RightAnkle) and a left ankle (LeftAnkle).

In some possible implementations, the human body key points that have been detected can be directly used to label corresponding human body part information. For example, if a key point RightEye is detected, the right eye is labeled to be visible.

In other possible implementations, the human body part information can be obtained as follows:

step A1, detecting the human body key points of the image to be labeled, to obtain the human body key points;

firstly, detecting the human body key points of the image to be labeled by using the pose estimation algorithm.

step A2, determining human body part dividing lines according to the human body key points; and

after detecting the human body key points, the human body part dividing lines are determined according to the human body key points. For example, six human body part dividing lines are set in the embodiment of the present disclosure.

A human body part dividing line 1 is a horizontal central line of five human body key points: a key point Nose, a key point RightEye, a key point LeftEye, a key point RightEar and a key point LeftEar;

a human body part dividing line 2 is a horizontal line formed by a key point RightShoulder and a key point LeftShoulder;

a human body part dividing line 3 is a horizontal line formed by a key point RightBow and a key point LeftBow;

a human body part dividing line 4 is a horizontal line formed by a key point RightHip and a key point LeftHip;

a human body part dividing line 5 is a horizontal line formed by a key point RightKnee and a key point LeftKnee; and

a human body part segmentation line 6 is a horizontal line formed by a key point RightAnkle and a key point LeftAnkle.

After the human body key points are detected, which human body part dividing lines exist in the human body can be determined, according to the human body key points that have been detected of the same human body. For example, if the key point RightBow and the key point LeftBow are detected by the human body, it is indicated that the human body part dividing line 3 is occurred.

step A3, determining the human body part information according to the human body part dividing lines.

The human body part information can include human body visible part information, a first human body truncation proportion and a second human body truncation proportion.

The human visible part information represents what part of the human body is visible. The first human body truncation proportion represents a proportion of a truncation distance above the human body to a total height of the human body, and the second human body truncation proportion represents a proportion of a truncation distance between a middle and lower part of the human body to the total height of the human body.

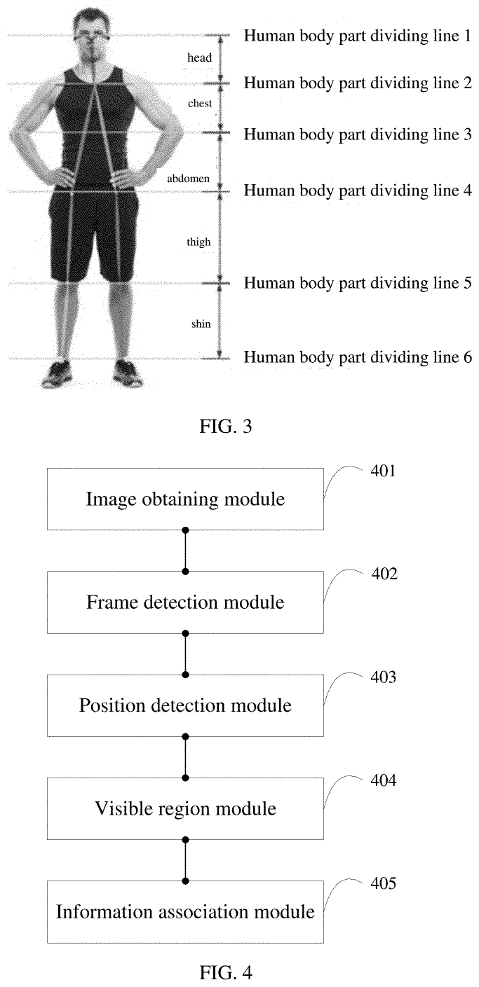

After the human body part dividing line is obtained, the human body visible part information can be determined according to the human body part dividing line that has obtained. Taking FIG. 3 as an example, if both the human body part dividing line 1 and the human body part dividing line 2 are visible, it is indicated that the head is visible; if both the human body part dividing line 2 and the human body part dividing line 3 are visible, it is indicated that the chest is visible; if both the human body part dividing line 3 and the human body part dividing line 4 are visible, it is indicated that the abdomen is visible; if both the human body part dividing line 4 and the human body part dividing line 5 are visible, it is indicated that the thighs are visible; if both the human body part dividing line 5 and the human body part dividing line 6 are visible, it is indicated that the shins are visible.

When labeling the human body visible part information, a Boolean vector with a length of 5 can be set to sequentially represent the visibility of the head, the chest, the abdomen, the thighs and the shins from left to right. If the corresponding part is visible, it is set to 1; otherwise, it is set to 0.

When calculating the first human body truncation proportion and the second human body truncation proportion, it first needs to solve the proportion of each part of the human body.

In an actual test process, 20 standing complete human body images are selected, and proportions of five human body parts in the complete human body are respectively obtained by detecting the key points of pedestrians in the 20 images.

For a single human body, a calculation rule is as follows:

Firstly, pixel distances between adjacent human body part dividing lines are calculated, which can be expressed as (ny1, ny2, ny3, ny4, ny5). Wherein, nyi represents a pixel distance between a human body part dividing line i and a human body part dividing line (i+1), and i=1, 2, 3, 4, 5.

And then, normalization processing is performed to calculate a proportion of each human part in the whole human body:

$$ryi = \frac{n y i}{n y 1 + n y 2 + n y 3 + n y 4 + n y 5}$$

wherein, ry1 represents the proportion of the head in the whole human body; ry2 represents the proportion of the chest in the whole body; ry3 represents the proportion of the abdomen in the whole body; ry4 represents the proportion of the thighs in the whole body; ry5 represents the proportion of the shins in the whole human body.

Calculating an average value of the proportion of each human body part of the 20 pedestrians in the whole human body, to obtain the proportion of dividing the human body parts. According to statistics, the proportion of the five human body parts is: head: chest: abdomen: thighs: shins=0.18:0.14:0.17:0.24:0.20. In addition, the proportion of a part above the human body part dividing line 1, and the proportion of a part below the human body part dividing line 6 are about 0.06 respectively.

In some possible implementations, the first human body truncation proportion and the second human body truncation proportion can be determined, directly according to the uppermost human body part dividing line and the lowest human body part dividing line of the detected human body. For example, the uppermost human body part dividing line is a line 2, it is indicated that the head is truncated and the head accounts for 13.7% of the whole human body, so that the first human body truncation proportion is 13.7%; the lowest human body part dividing line is a line 4, it means that the thighs and the shins are truncated, and the thighs and the shins account for 50.7% of the whole human body, so that the second human body truncation proportion is 50.7%.

In some possible implementations, a human body upper truncation distance above the human body and a human body lower truncation distance below the human body can be calculated through other ways, and then the first human body truncation proportion and the second human body truncation proportion can be calculated, according to the truncation distance above the human body and the truncation distance below the human body, which are as follows:

In the case of the human body is truncated in the image, not all six human body part dividing lines are presented. Therefore, in practical applications, it is necessary to estimate a total height of the human body or a pixel length of an unknown part through a certain part. For example, it is known that a pixel length of the head is T, the total height of the human body can be calculated according to T/ry1; alternatively, a pixel length D of the thighs is unknown, the pixel length of the thighs can be calculated according to T/D=1/1.7.

Because a range of motion amplitudes of different parts of the human body is different (for example, a motion range of a wrist joint relative to a shoulder joint is far larger than that of the chest relative to the abdomen), therefore, a corresponding strategy for calculating the total height of the human body can be formulated, according to variation ranges of different human body parts in the vertical direction. Generally, the human body part, with a smaller variation range due to motion, has a higher priority.

In some possible implementations, the strategy for calculating the total height of the human body is as follows:

B 1, if the human body part dividing line 1 and the human body part dividing line 4 exist, then:

$$H = \frac{n y 1 + n y 2 + n y 3}{r y 1 + r y 2 + r y 3}$$

otherwise, B2 is executed.

B2, if the human body part dividing line 4 and the human body part dividing line 4 exist, then:

$$H = \frac{n y 4}{r y 4}$$

otherwise, B3 is executed.

B3, if the human body part dividing line 5 and the human body part dividing line 6 exist, then:

$$H = \frac{n y 5}{r y 5}$$

otherwise, B4 is executed.

B4, if the human body part dividing line 2 and the human body part dividing line 3 exist, then:

$$H = \frac{n y 2}{r y 2}$$

otherwise, B5 is executed.

B5, if the human body part dividing line 3 and the human body part dividing line 4 exist, then:

$$H = \frac{n y 3}{r y 4}$$

otherwise, B6 is executed.

B6, if the human body part dividing line 1 and the human body part dividing line 2 exist, then:

$$H = \frac{n y 1}{r y 1}$$

otherwise, H=0, which is as a mark indicating that an estimated human body height is invalid.

Wherein, H represents the total height of the human body.

When calculating the human body upper truncation distance:

C1, if the human body part dividing line 1 exists, then:

d=H*0.06

otherwise, C2 is executed.

C2, if the human body part dividing line 2 exists, then:

d=H*0.18

otherwise, C3 is executed.

C3, if the human body part dividing line 4 exists, then:

d=H*0.49

otherwise, C4 is executed.

C4, if the human body part dividing line 3 exists, then:

d=H*0.32

otherwise, d is zero.

Wherein, d is a first intermediate parameter. The ordinate Y of the human body part dividing line 1 can be directly obtained or calculated from known human body part dividing lines.

The human body upper truncation distance is Ptop:

Ptop=max(0,d−Y)

Wherein, max is a symbol of a maximum value.

When calculating the human body lower truncation distance:

D1, if the human body part dividing line 6 exists, then:

k=H*0.06

otherwise, D2 is executed.

D2, if the human body part dividing line 5 exists, then:

k=H*0.26

otherwise, D3 is executed.

D3, if the human body part dividing line 4 exists, then:

k=H*0.5

otherwise, D4 is executed.

D4, if the human body part dividing line 2 exists, then:

k=H*0.81

otherwise, D5 is executed.

D5, if the human body part dividing line 3 exists, then:

k=H*0.67

otherwise, k is zero.

The human body lower truncation distance is Pbtm:

Pbtm max(0,d+Y—height)

Wherein, k is a second intermediate parameter, and height is a height of the image.

After the human body upper truncation distance and the human body lower truncation distance are calculated, the first human body truncation proportion and the second human body truncation proportion can be calculated accordingly:

Rtop=Ptop/(Ptop+Pbtm+height)

Rbtm=Pbtm/(Ptop+Pbtm+height)

Wherein, Rtop is the first human body truncation proportion, and Rbtm is the second human body truncation proportion.

In an embodiment of the present disclosure, the human body part dividing line is determined according to the human body key points, and the human body part information is determined according to the human body part dividing line. It is not necessary to label whether all key points are visible when the human body part information is labeled, so that labeling lengths of the human body part information can be shortened, the human body part information can be easily determined, labeling efficiency can be improved, and the human body completeness estimation model can be easily trained.

step S204, detecting a human body region of the image to be labeled, to obtain human body visible region labeling information;

an example segmentation algorithm is provided to detect the human body region of the image to be labeled, to obtain the human body visible region labeling information.

A type of the example segmentation algorithm can be selected according to actual requirements. In some possible implementations, a Mask-RCNN algorithm can be selected as the example segmentation algorithm, and the human body region detection is performed on the image to be labeled through the Mask-RCNN algorithm, to obtain the human body visible region labeling information.

In the process of implementing the example segmentation algorithm, requirements on a precision of labeling the human body are low. In order to reduce calculation amount of subsequent applications, the image can be divided into a plurality of image blocks according to a preset division mode. For each image block, if the number of pixels labeled as 1 by the example segmentation algorithm exceeds a preset number, the image block is labeled to be visible. In this way, the calculation amount of subsequent applications can be reduced by reducing a labeling granularity of the example segmentation algorithm.

The preset division mode can be set according to actual conditions. For example, the preset division mode can be that the image is divided into 16 equal parts in the vertical direction, and 8 equal parts in the horizontal direction, so that the image can be divided into an image block matrix with a resolution of 16×8 according to the preset division mode.

The preset number can be set according to actual conditions. For example, the preset number can be set to 30% of a total number of pixels within the image block.

step S205, determining the human body part information associated with the first human body frame, and determining the human body visible region labeling information associated with the first human body frame, to finish labeling the human body completeness data of the first human body frame.

After the first human body frame, the human body part information and the human body visible region information are obtained, because a plurality of pedestrians can exist in the image, it is necessary to determine the human body part information corresponding to the first human body frame, and the human body visible region labeling information of the first human body frame, and an association relationship between the first human body frame, the human body part information and the human visible region labeling information is established, so as to finish labeling the human body completeness data of the first human body frame.

In some possible implementations, the step of determining the human body part information associated with the first human body frame, includes:

step E1, obtaining a second human body frame corresponding to the human body part information;

after the human body key points are obtained, the second human body frame corresponding to the human body part information can be obtained according to the human body key points.

For example, in some possible implementations, after a human body key point of a certain human body is detected, a minimum human body frame that surrounds all human body key points of the human body can be created, and the minimum human body frame is determined as the second human body frame; or, according to parameters set by the user, the minimum human body frame is expanded outward by a certain size, to obtain the second human body frame.

step E2, determining the human body part information associated with the first human body frame, according to position information of each second human body frame in the first human body frame, and an intersection-over-union (IoU) of the first human body frame and each second human body frame.

The first human body frame can intersect with a plurality of second human body frames. At this time, the second human body frame associated with the first human body frame can be determined, according to the position information of each of the plurality of second human body frames in the first human body frame, and the intersection-over-union (IoU) of the first human body frame and each of the plurality of second human body frames, and then the human body part information associated with the first human body frame can be determined.

In some possible implementations, the step of determining the human body visible region labeling information associated with the first human body frame, includes:

step F 1, obtaining a third human body frame corresponding to the human body visible region labeling information;

after the human body visible region labeling information is obtained, the third human body frame corresponding to the human body visible region labeling information can be obtained, according to the human body visible region labeling information.

step F2, determining the human body visible region labeling information associated with the first human body frame, according to position information of each third human body frame in the first human body frame, and an intersection-over-union (IoU) of the first human body frame and each third human body frame.

The first human body frame can intersect with a plurality of third human body frames. At this time, the third human body frame associated with the first human body frame can be determined, according to the position information of each of the plurality of third human body frames in the first human body frame, and the intersection-over-union (IoU) of the first human body frame and each of the plurality of third human body frames, and then the human body visible region labeling information associated with the first human body frame can be determined.

According to the embodiment of the present disclosure, the human body part information associated with the first human body frame is determined, according to the position information of the second human body frame, and the intersection-over-union of the second human body frame and the first human body frame, and the human body visible region labeling information associated with the first human body frame is determined, according to the position information of the third human body frame, and the intersection-over-union of the third human body frame and the first human body frame, therefore, matching accuracy can be improved, the human body part information and the human body visible region labeling information are correctly matched with the first human body frame, and matching errors can be avoided as much as possible.

The above matching process is described below in combination with practical application scenarios:

Taking the first human body frame as Bbox, a plurality of human bodies can exist in the first human body frame, that is, a plurality of second human body frames and a plurality of third human body frames can exist to intersect with the first human body frame Bbox.

Establishing index numbers of the plurality of second human body frames and the plurality of third human body frames which are respectively intersected with the first human body frame, for example, the index numbers of the plurality of second human body frames can be 2001, 2002, 2003 and so on; and the index numbers of the plurality of third body frames can be 3001, 3002, 3003 and so on.

The intersection-over-union IOU represents a proportion of an intersection portion that the second human body frame is intersected with the first human body frame, to the first human body frame, or a proportion of an intersection portion that the second human body frame is intersected with the first human body frame, to the first human body frame. An intersection-over-union index Iᵢₒᵤ represents the index number of the second human frame or the third human frame with the greatest intersection-over-union.

A horizontal index Iₓ represents the index number of the second human body frame or the third human body frame with the smallest distance from a perpendicular bisector of the first human body frame along the horizontal direction.

A vertical index I_{y} represents the index number of the second human body frame or the third human body frame with the smallest distance from the top of the first human body frame along the vertical direction.

A human body proportion height Ratio represents a ratio of a distance from the human body part dividing line 1 in the second human body frame or the third human body frame to the top of the image, to the whole length of the human body.

A matching rule is as follows:

G1, if Iₓ=I_{y}=Iᵢₒᵤ, max(IOU)>0.7, and Ratio corresponding to Iₓ, is less than 0.2, then: Iₒₚₜᵢₘₐₗ=Iₓ; otherwise, G2 is executed;

G2, if Iₓ=I_{y}=Iᵢₒᵤ, Ratio corresponding to Iₓ, is less than 0.2, then: Iₒₚₜᵢₘₐₗ=Iₓ; otherwise, G3 is executed;

G3, if Iₓ=Iᵢₒᵤ, then: Iₒₚₜᵢₘₐₗ=Iᵢₒᵤ; otherwise, G4 is executed;

G4, if Ratio corresponding to Iₓ, is less than 0.2, then: Iₒₚₜᵢₘₐₗ=I_{y}; otherwise, G5 is executed;

G5, if I_{y}=Iᵢₒᵤ, then: Iₒₚₜᵢₘₐₗ=Iᵢₒᵤ; otherwise, G6 is executed;

G6, Iₒₚₜᵢₘₐₗ=Iᵢₒᵤ.

Wherein, Iₒₚₜᵢₘₐₗ represents the index number of the second human body frame or the third human body frame associated with the first human body frame.

The matching process of the second human frame and the first human frame is consistent with that of the third human frame and the first human frame, and the matching process of the second human frame and the first human frame, is independent from that of the third human frame and the first human frame.

Taking the matching process of the second human body frame and the first human body frame as an example, it is assumed that the first human body frame intersects with three second human body frames, the index numbers of the three second body frames are set to 2001, 2002, and 2003, respectively.

The intersection-over-union of the second human body frame, with the index number of 2002, and the first human body frame is the greatest, then: Iᵢₒᵤ=2002.

A distance between the second human body frame with the index number of 2002, and the perpendicular bisector of the first human body frame along the horizontal direction, is the smallest, then: Iₓ=2002.

A distance between the second human body frame with the index number of 2003, and the top of the first human body frame along the vertical direction, is the smallest, then: I_{y}=2003.

At this time, Iₓ=Iᵢₒᵤ≈I_{y}, which is not met conditions G1 and G2, then, G3 is executed, that is, Iₒₚₜᵢₘₐₗ=Iᵢₒᵤ=2002, it is indicated that the second human body frame with the index number of 2002 matches with the first human body frame, and the first human body frame is associated with the human body part information corresponding to the second human body frame with the index number of 2002.

It can be understood that the above matching rule and matching process are only illustrative examples in practical application scenarios. In actual application scenarios, the matching rule and the matching process can be appropriately adjusted, for example, a part of the matching rule can be added or deleted, and the foregoing examples shall not constitute any limitation on the embodiments of the present disclosure.

The method for labeling the human body completeness data according to the first embodiment of the present disclosure is provided for automatically labeling the human body completeness data, by combining with the target detection algorithm, the pose estimation algorithm, and the example segmentation algorithm. The target detection algorithm can detect positions of the human body in the image to obtain the first human body frame, rather than detecting which regions in the first human body frame are human body visible regions, and the human body part information corresponding to the human body visible regions. The pose estimation algorithm can detect the human body part information, rather than detecting the human body visible region labeling information, and providing enough occluded information. The example segmentation algorithm can detect the human body visible region labeling information, rather than detecting the human body part information corresponding to the human body visible region labeling information. The present disclosure is provided for organically combining the target detection algorithm, the pose estimation algorithm and the example segmentation algorithm, to determine the first human body frame where the human body is located, and the human body part information and the human body visible region labeling information, respectively corresponding to the first human body frame, and automatically finish labeling the human body completeness data of the first human body frame, rather than requiring manual participation, thereby manpower and material resources are reduced, the labeling speed is improved, rapid iteration of products is facilitated. Therefore, the present disclosure can solve problems in the related art that a lot of manpower and material resources are consumed, a long time to label human completeness data is occurred, errors are prone to be occurred, and are against rapid iteration of products by manually labeling the human completeness data.

When determining the human body part information, the human body part dividing line can be determined according to the human body key points that have been detected, and the human body part information is determined according to the human body part dividing line. It is not necessary to label whether all key points are visible, when the human body part information is labeled, so that labeling lengths of the human body part information can be shortened, the human body part information can be easily determined, labeling efficiency can be improved, and the human body completeness estimation model can be easily trained.

The human body part information corresponding to the first human body frame, and the human body visible region labeling information associated with the first human body frame, can be determined, according to the position information of the second human body frame and the third human body frame, the intersection-over-union of the second human body frame and the first human body frame, and the intersection-over-union of the third human body frame and the first human body frame. In this way, the above matching can be performed through the positions of the second human body frame and the third human body frame, and their corresponding intersection-over-unions, the matching accuracy can be improved, the human body part information and the human body visible region labeling information are correctly matched with the first human body frame, and matching errors can be avoided as much as possible.

It should be understood that sequence numbers of the steps in the above embodiments do not imply orders to be performed, sequences that each process is performed shall be determined by its function and internal logics, rather than to constitute any limitation to perform the embodiments of the present disclosure.

### A Second Embodiment

The second embodiment provides an apparatus for labeling human body completeness data in accordance with an embodiment of the present disclosure, for ease of illustration, only those parts that are relevant to the present disclosure are shown, referring to FIG. 3, the apparatus includes:

an image obtaining module 401 configured to obtain an image to be labeled;

a frame detection module 402 configured to perform human body detection on the image to be labeled, to obtain a first human body frame;

a position detection module 403 configured to detect human body key points of the image to be labeled, and determine human body part information according to the human body key points that have been detected;

a visible region module 404 configured to detect a human body region of the image to be labeled, to obtain human body visible region labeling information; and

an information association module 405 configured to determine human body part information associated with the first human body frame, and determine the human body visible region labeling information associated with the first human body frame, to finish labeling the human body completeness data of the first human body frame.

In some possible implementations, the position detection module 403 includes:

a key point sub-module configured to detect the human body key points of the image to be labeled, to obtain the human body key points;

a dividing line sub-module configured to determine human body part dividing lines according to the human body key points; and

a part information sub-module configured to determine the human body part information according to the human body part dividing lines.

In some possible implementations, the human body part information includes: human body visible part information, a first human body truncation proportion and a second human body truncation proportion.

In some possible implementations, the information association module 405 includes:

a second frame sub-module configured to obtain a second human body frame corresponding to the human body part information; and

a part matching sub-module configured to determine the human body part information associated with the first human body frame, according to position information of each second human body frame in the first human body frame, and an intersection-over-union (IoU) of the first human body frame and each second human body frame.

In some possible implementations, the information association module 405 includes:

a third frame sub-module configured to obtain a third human body frame corresponding to the human body visible region labeling information; and

a region matching sub-module configured to determine the human body visible region labeling information associated with the first human body frame, according to position information of each third human body frame in the first human body frame, and an intersection-over-union (IoU) of the first human body frame and each third human body frame.

In some possible implementations, the frame detection module 402 is specifically configured to perform the human body detection on the image to be labeled through a target detection algorithm to obtain the first human body frame.

In some possible implementations, the position detection module 403 is specifically configured to detect the human body key points of the image to be labeled through a pose estimation algorithm, and determine the human body part information according to the human body key points that have been detected;

the visible region module 404 is specifically configured to detect the human body region of the image to be labeled through an example segmentation algorithm, to obtain the human body visible region labeling information.

It should be noted that information interaction and execution processes between the above devices/units are based on the same conception as the embodiments of the present disclosure, therefore, specific functions and technical effects brought by the above devices/units can be detailed in the embodiments of the present method, which will not be repeated here.

### A Third Embodiment

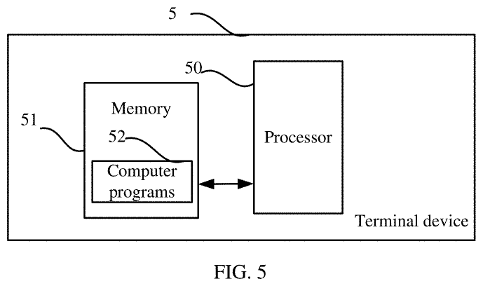

FIG. 5 is a schematic diagram of a terminal device in accordance with a third embodiment of the present disclosure. Referring to FIG. 5, the terminal device 5 includes: a processor 50, a memory 51 and computer programs 52 stored in the memory 51 and performed by the processor 50 to implement steps of the method for labeling human body completeness data mentioned above, such as steps S201-205 shown in FIG. 1. Or, the processor 50 is configured to perform the computer programs 52 to implement functions of the modules/units of the embodiments described in the apparatus for labeling human body completeness data mentioned above, such as the functions of the modules 401-405 shown in FIG. 2.

Specifically, the computer program 52 can be segmented into one or more modules/units that are stored in the memory 51 and performed by the processor 50 to implement the present disclosure. The one or more modules/units can be a series of computer program instruction segments capable of performing specific functions, which are configured to describe execution of the computer programs 52 in the terminal device 5. For example, the computer programs 52 can be segmented to the image obtaining module, the frame detection module, the position detection module, the visible region module and the information association module, and specific functions of each of the above modules are as follows:

the image obtaining module configured to obtain an image to be labeled;

the frame detection module configured to perform human body detection on the image to be labeled, to obtain a first human body frame;

the position detection module configured to detect human body key points of the image to be labeled, and determine human body part information according to the human body key points that have been detected;

the visible region module configured to detect a human body region of the image to be labeled, to obtain human body visible region labeling information;

the information association module configured to determine human body part information associated with the first human body frame, determine the human visible region labeling information associated with the first human body frame, to finish labeling the human body completeness data of the first human body frame.

The terminal device 5 can be a computing device such as a desktop computer, a notebook, a handheld computer and a cloud server. The terminal device 5 can include, but is not limited to, a processor 50 and a memory 51. An ordinary skilled person in the art can be understood that: FIG. 5 is only an example of the terminal device 5, but is not limited to the terminal device 5 which can include more or less components than FIG. 5, or some combination of components, or different components. For example, the terminal device 5 can also include input/output devices, network access devices, buses, etc.

The processor 50 can be a Central Processing Unit (CPU), other general-purpose processors, a Digital Signal Processor (DSP), an Application Specific Integrated Circuit (ASIC), a Field-Programmable Gate Array (FPGA) or other programmable logic devices, discrete gates or transistor logic devices, discrete hardware components, etc. The general-purpose processor can be a microprocessor or any conventional processors, etc.

The memory 51 can be an internal storage unit within the terminal device 5, such as a hard disk or a memory of the terminal device 5. The memory 51 can also be an external storage device of the terminal device 5, such as a plug-in hard disk, a Smart Media Card (SMC), a Secure Digital (SD) Card, and a Flash Card, etc. equipped on the terminal device 5. Furthermore, the memory 51 can also include both an internal storage unit of the terminal device 5 and an external storage device. The memory 51 is configured to store computer programs and other programs and data required by the terminal device 5, and temporarily store data that has been output or to be output.

An ordinary skilled person in the art can be clearly understood that: for convenient and simple description, the above functional units and modules are only divided to illustrate with examples. In a practical application, different functional units and modules can be assigned to implement the above functions according to needs, that is, internal structures of the apparatus can be divided into different functional units or modules to complete all or part of the functions described above. Each functional unit or each module in embodiments of the present disclosure can be integrated in a processing unit, or each unit can be physically existed separately, or two or more units can be integrated in a unit. The above-mentioned integrated units can be realized in the form of hardware or software functional units. In addition, specific names of each functional unit and each module are only to conveniently distinguish with each other, but are not limited to the protection scope of the present disclosure. A specific working process of the units and modules in the above system can be referred to the corresponding process in the embodiment of the above method, which is not repeated here.

In the above embodiments, the description of each embodiment has its own emphasis, and parts without detailed description in one embodiment can be referred to relevant description of other embodiments.

An ordinary skilled person in the art can be aware that various illustrative units and algorithm steps described in connection with the embodiments disclosed herein can be implemented as electronic hardware or combinations of computer software and electronic hardware. Whether these functions are performed in hardware or software modes depends on a specific application of the technical solution and design constraints. Professionals can use different methods for each specific application to achieve the functions described, but such implementation should not be considered outside the scope of this application.

It should be understood that the disclosed apparatus/terminal and method in the embodiments provided by the present disclosure can be implemented in other ways. For example, the embodiments of the apparatus/terminal described above are merely schematic; for example, the division of the modules or units is merely a division of logical functions, which can also be realized in other ways; for example, multiple units or components can combined or integrated into another system, or some features can be ignored or not implemented. On the other hand, the coupling, direct coupling or communication connection shown or discussed may be achieved through some interfaces, indirect coupling or communication connection between devices or units may electrical or otherwise.

The units described as separation parts can or can't be physically separated, and the parts displayed as modules can or can't be physical units, that is, they can be located in one place, or can be distributed on a plurality of network units. Some or all of the units can be selected according to actual needs to implement the purpose of the present disclosure.

In addition, each functional unit in each embodiment of the present disclosure can be integrated in a processing unit, or each unit can be separately formed with a physical form, or two or more units can be integrated in one unit. The above integrated units can be implemented either in a hardware form or in the form of hardware plus software function modules.

The integrated modules/units can be stored in a computer readable memory if implemented in the form of software program modules and sold or used as a separate product. Based on this understanding, all or part of the steps in the method of the above embodiment in the present disclosure can be implemented by computer program instructions of relevant hardware which can be stored in a computer readable storage medium, the computer program can be performed by the processor to implement the steps in the various methods of the above embodiments. Furthermore, the computer program includes computer program codes, which can be in a form of source codes, object codes, executable files or some intermediate forms, etc. The computer readable medium can include: any entities or devices capable of carrying the computer program codes, a recording medium, a U disk, a mobile hard disk drive, a diskette or a CD-ROM, a computer Memory, a Read-Only Memory (ROM), a Random Access Memory (RAM), an electrical carrier signal, a telecommunication signal and a software distribution medium, etc. It should be noted that content contained in the computer readable storage medium can be added or reduced as appropriate to the requirements of legislation and patent practice within the jurisdictions, for example, in some jurisdictions, in accordance with legislation and patent practice, computer readable storage medium do not include electrical carrier signals and telecommunications signals.

The above embodiments are used only to describe, but not limited to, the technical solution of the present disclosure. Although the features and elements of the present disclosure are described as embodiments in particular combinations, an ordinary skilled person in the art should understand that: each feature or element can be used alone or in other various combinations within the principles of the present disclosure to the full extent indicated by the broad general meaning of the terms in which the appended claims are expressed. Any variation or replacement made by one of ordinary skill in the art without departing from the spirit of the present disclosure shall fall within the protection scope of the present disclosure.

1. A method for labeling human body completeness data comprising:
obtaining an image to be labeled;
performing human body detection on the image to be labeled, to obtain a first human body frame;
detecting human body key points of the image to be labeled, and determining human body part information according to the human body key points that have been detected;
detecting a human body region of the image to be labeled, to obtain human body visible region labeling information; and
determining human body part information associated with the first human body frame, and determining the human body visible region labeling information associated with the first human body frame, to finish labeling the human body completeness data of the first human body frame.

2. The method as claimed in claim 1, wherein the step of detecting the human body key points of the image to be labeled, and determining the human body part information according to the human body key points that have been detected, comprises:
detecting the human body key points of the image to be labeled, to obtain the human body key points;
determining human body part dividing lines according to the human body key points; and
determining the human body part information according to the human body part dividing lines.

3. The method as claimed in claim 1, wherein the step of determining the human body part information associated with the first human body frame, comprises:
obtaining a second human body frame corresponding to the human body part information; and
determining the human body part information associated with the first human body frame, according to position information of each second human body frame in the first human body frame, and an intersection-over-union (IoU) of the first human body frame and each second human body frame.

4. The method as claimed in claim 1, wherein the step of determining the human body visible region labeling information associated with the first human body frame, comprises:
obtaining a third human body frame corresponding to the human body visible region labeling information; and
determining the human body visible region labeling information associated with the first human body frame, according to position information of each third human body frame in the first human body frame, and an intersection-over-union (IoU) of the first human body frame and each third human body frame.

5. The method as claimed in claim 1, wherein the step of performing human body detection on the image to be labeled, to obtain the first human body frame, comprises: performing the human body detection on the image to be labeled through a target detection algorithm, to obtain the first human body frame.

6. The method as claimed in claim 1, wherein the step of detecting the human body key points of the image to be labeled, and determining the human body part information according to the human body key points that have been detected, comprises:
detecting the human body key points of the image to be labeled through a pose estimation algorithm, and determining the human body part information according to the human body key points that have been detected;
the step of detecting the human body region of the image to be labeled, to obtain the human body visible region labeling information, comprising:
detecting the human body region of the image to be labeled through an example segmentation algorithm, to obtain the human body visible region labeling information.

7. An apparatus for labeling human body completeness data applied to an electronic apparatus, the electronic apparatus comprising a processor and a memory and one or more computerized program modules stored in the memory, the one or more computerized program modules comprising instructions performed by the processor of the electronic apparatus, the modules comprising:
an image obtaining module configured to obtain an image to be labeled;
a frame detection module performed by the processor and configured to perform human body detection on the image to be labeled, to obtain a first human body frame;
a position detection module performed by the processor and configured to detect human body key points of the image to be labeled, and determine human body part information according to the human body key points that have been detected;
a visible region module performed by the processor and configured to detect a human body region of the image to be labeled, to obtain human body visible region labeling information; and
an information association module performed by the processor and configured to determine human body part information associated with the first human body frame, and determine the human body visible region labeling information associated with the first human body frame, to finish labeling the human body completeness data of the first human body frame.

8. The apparatus as claimed in claim 7, wherein the position detection module comprises:
a key point sub-module configured to detect the human body key points of the image to be labeled, to obtain the human body key points;
a dividing line sub-module configured to determine human body part dividing lines according to the human body key points; and
a part information sub-module configured to determine the human body part information according to the human body part dividing lines.

9. A terminal device comprising a memory, a processor and computer programs stored in the memory and performed by the processor to implement a method for labeling human body completeness data, the method comprising:
obtaining an image to be labeled;
performing human body detection on the image to be labeled, to obtain a first human body frame;
detecting human body key points of the image to be labeled, and determining human body part information according to the human body key points that have been detected;
detecting a human body region of the image to be labeled, to obtain human body visible region labeling information; and
determining human body part information associated with the first human body frame, and determining the human body visible region labeling information associated with the first human body frame, to finish labeling the human body completeness data of the first human body frame.

10. (canceled)
